(19) United States
(12) Patent Application Publication
(10) Pub. No.: US 2006/0018270 A1
(43) Pub. Date: Jan. 26, 2006

(54) Method and system for n-way synchronization with partial or full content

(76) Inventors: Richard A. Forand, Portland, OR (US); Gunner D. Danneels, Beaverton, OR (US); Riley W. Jackson, Portland, OR (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/882,550

(22) Filed: Jun. 30, 2004

(51) Int. Cl. H04B 7/212

(52) U.S. Cl. 370/324

(57) ABSTRACT

A system and method for receiving a list of data item during a process synchronizing data on a mobile device. One embodiment, of the method includes replacing one or more data items if a quality factor of a corresponding data item received is higher than the corresponding data item previously stored on the mobile device. In one embodiment, the method further includes saving one or more data items received if the data items were not previously stored on the mobile device. The mobile device is one of a set comprising of a mobile computer, a personal digital assistant (PDA), cellular phone.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention generally relates to the field of data communications. More particularly, an embodiment of the present invention relates to an n-way synchronization of with partial or full content.

### BACKGROUND

Desire for continuous access to greater amounts of information have continued to increase. In the evolvement of greater mobile working environments, users desire to have access to their data on their mobile devices such as their cell phone, their mobile computers, and their personal digital assistants (PDA.)

A key characteristic of these mobile devices is that they have heterogeneous and intermittent connectivity to a corporate information repository. For example, the mobile computer may be connected with a WLAN while it is in a hotspot, but when out of radio range, there is no connectivity. The cell phone has a different type of connectivity, typically low bandwidth but more continuous. Therefore, in order to have access to their data, one or more of a user's mobile devices are usually synchronized with a master database, such as a mail server, to have copies of their emails, etc. on their mobile devices. Then, this offline copy of the data is used when the device is unable to connect to the information repository. However, complexity is introduced by two factors, the nature of the communication system and the capabilities of the mobile device.

The nature of the communication system can be characterized by three factors, bandwidth, cost, and connectivity. A notebook computer may access the mail server via a high bandwidth corporate wireless local area network (WLAN) network, while a cell phone may access the server via a lower bandwidth GPRS WWAN connection. Typically, the per bit cost of a WWAN connection is much higher than for a WLAN connection. And finally connectivity may range from a relatively small radius around a WLAN hotspot to nearly continuous GPRS coverage.

Additional complexity is added by the characteristics of the individual device. For example, it is quite easy to store a large e-mail attachment on the user's notebook computer's hard drive, but the user's cell phone may not have the necessary storage.

Current data synchronization techniques among mobile devices typically make two key assumptions. First that all data can be simply copied from a master database to all devices unchanged and secondly that the source of the information remains fixed. For example, the PDA will always receive its information from the mobile computer's synchronized copy of the user's email. While this works for a set of devices that do not have multiple mechanisms to connect dynamically to the central repository, the data may be available via a different path and is not necessarily out of synchronization if only limited information is available on a given device due to constraints of memory or bandwidth.

### BRIEF DESCRIPTION OF THE DRAWINGS

The invention is illustrated by way of example and not limitation in the figures of the accompanying drawings, in which like references indicate similar or identical elements, and in which:

FIG. 1 illustrates an exemplary block diagram of a network including remote devices for implementing one embodiment of the present invention;

FIG. 2 is a flow diagram describing the processes in accordance with one embodiment;

FIGS. 3a-e illustrate an example of the processes in accordance with one embodiment of the invention;

FIG. 4 an exemplary block diagram of a network including remote device for implementing one embodiment of the present invention; and

FIGS. 5a-e illustrate an example of the processes in accordance with one embodiment of the invention.

### DETAILED DESCRIPTION

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

One embodiment of the present invention offers a method and system for synchronization of a variety of remote devices (notebook, PDA, cell-phone, etc.) to keep a user's devices up to date. In one embodiment, any two devices can synchronize their data received from prior contact with a master database. This can happen between as many devices as the user has (e.g. a user can synchronize his cell-phone, PDA, notebook etc.).

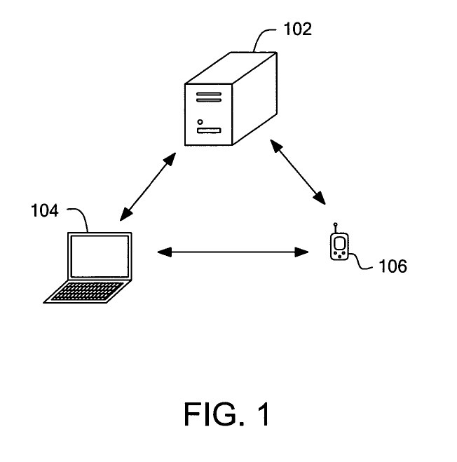

As illustrated in the network diagram of FIG. 1, one embodiment of the network includes a central master database server 102 (e.g. mail server) which receives updates from external network connections. A user's remote devices, such as a mobile computer 104 or cellular phone 106, may contact the server 102 to download updates via their own network connections with the server. These network connections may not be available at all times. For example, the mobile computer 104 may have a WLAN access to the server 102 that is not available outside of the corporation's office. Therefore, these devices may synchronize with each other given the current state of the network connections. Additionally, the remote devices may provide data synchronization with other remote devices.

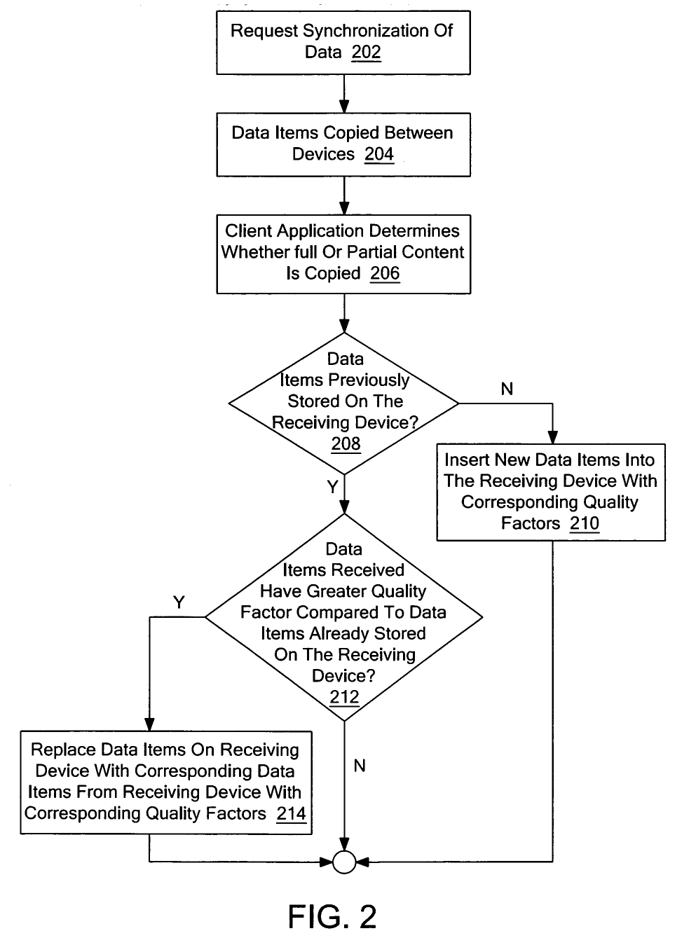

FIG. 2 illustrates a flow diagram describing the processes of providing synchronization among remote devices, including between two or more remote/mobile devices, or between a repository and one or more remote/mobile devices, in accordance with one embodiment. In process 202, a user requests synchronization of data items from a first device to a second device. The first device may have previously performed a download of data from the master database (e.g., repository.) or may itself be the master database. The data items to be synchronized may be any of email, data entries, and other forms a data. Examples of possible devices include, but are not limited to, remote/mobile devices such as a mobile computer, a personal digital assistant (PDA), or a cellular phone.

In process 204, the data items are copied from the first device to the second device. The data items may be copied from the first device to the second device via variety of wireless techniques, including, but not limited to, a wireless local area network (WLAN), a Bluetooth wireless personal area network connection, a short range infrared device-to-device connection or a General Packet Radio Service (GPRS).

In process 206, in one embodiment, a client application on either of the devices may recognize limited capabilities on the second device, or limited bandwidth connection available between the first and second devices. As a result, one or more of the data items copied from the first device to the second device, may include only partial content. For example a copy of an email may not include an attachment.

In process 208, a client application on the second device determines if one or more of the data items from the first device were previously stored on the second device. If one or more of the data items were not previously stored on the second device, in process 210 the data items that were not previously stored on the second device are inserted into a data list or an organized storage of the second device, along with a quality factor indicator. This indicator reflects the relative quality of the data available and the level of alteration that has occurred in the path from the data master database/repository to this device. For instance, an email message with attachments removed to decrease the transmission bandwidth would have a lower quality factor than a copy of the same email that had the attachments still present.

If one or more of the data items from the first device were previously stored on the second device, in process 212 the client application compares a quality factor indicator of the data items currently stored on the second device with the corresponding data items received from the first device. If one or more of the data items received from the first device have a greater quality factor than a quality factor of a corresponding data item on the second device, in process 214 the data items received from the first device replaces the corresponding data items previously stored on the second device. In one embodiment, the processes of 202-214 are repeated for all the data items that are synchronized between the first and second devices. Furthermore, the client application that determines whether to replace a data item, or to insert a new data item, may be stored on either the first or second device.

There are additional operations other than simply sending information to a second device that make up the complete synchronization action. These are closely aligned with their current instantiations. The action of delete occurs as in current sync systems, items deleted on the second device are also deleted in the repository at the next synchronization. Modification of a data item is slightly different in that modifications are applied to the data item in the repository before quality is compared and data transmitted. For instance, suppose the user has a copy of a document that was converted from rich text to simple text for transmission to a device. If the user has altered the simple text version, the alterations would need to be applied to the original rich text document before the comparison of quality and the full quality version of the document transmitted to the device.

As a result, the method and system described provides improved synchronization to the end user, i.e. data is available faster, without a direct connection to the master database. In one embodiment, the method and system also improves peer-to-peer data synchronization systems because it comprehends the transforms in the data required for transmission across certain links, and adapts by obtaining better quality data whenever it can.

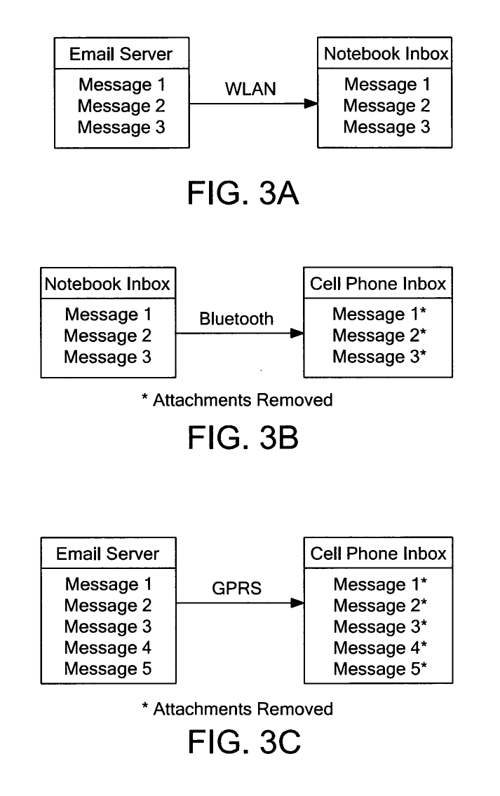

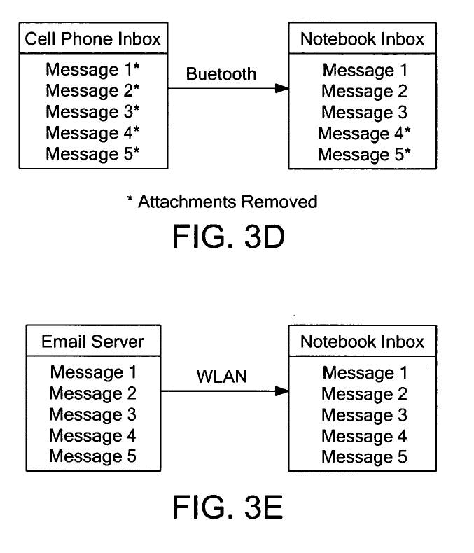

The following examples illustrate use of one or more embodiments. In a first example, suppose a business traveler has a notebook computer and a cell-phone both of which she would like to synchronize with her master email database. She initially downloads the email to her notebook from the email server over a high bandwidth WLAN connection in her workplace, as shown in FIG. 3a.

As she rides a train to the airport she decides to synchronize her cell-phone as well. But in order to avoid incurring GPRS charges, she elects to synchronize with the notebook over Bluetooth. The notebook email client recognizes the limited device capabilities of the cell-phone and transforms the emails by removing attachments. The cell-phone recognizes the out of date information in its database and replaces records as necessary to synchronize with the notebook, as shown in FIG. 3b. The traveler then stores her phone and boards the airplane and uses her notebook in flight.

Once in the destination airport the traveler cannot find a convenient WLAN hot-spot so takes out her cell-phone and connects with the master database via GPRS. The server sends two new messages to the cell-phone with attachments removed, as shown in FIG. 3c. The traveler then synchronizes the cell-phone and notebook over Bluetooth once more, the two new scaled down messages are copied from the phone to the notebook's inbox, as shown in FIG. 3d.

At the end of the day, the traveler then reaches her destination hotel and finds a local WLAN hot-spot so she connects her notebook to the master email server and replaces the two new messages in the notebook database with their full versions including attachments, as shown in FIG. 3e.

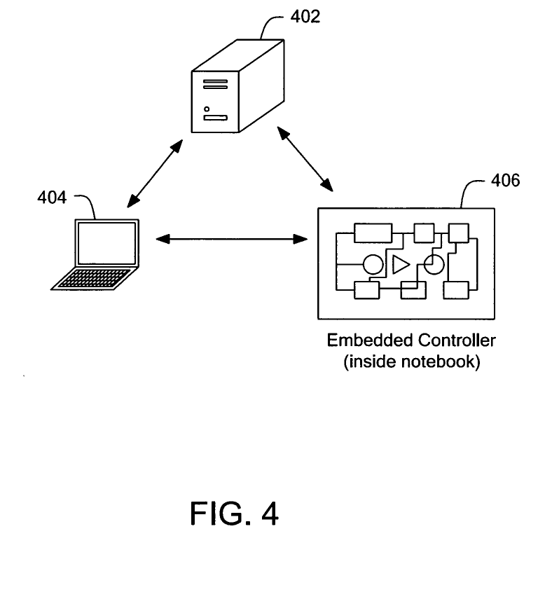

In a second example, illustrated in FIG. 4, a “Road-warrior” traveler using a notebook 404 that has an embedded controller (EC) 406 with GPRS. The embedded controller stays connected while the notebook enters a low power standby mode. Again the processes of one embodiment of synchronizing data among the remote devices is illustrated as in the previous example, except in the second example the embedded controller 406 is substituted for cell-phone. The database on board the controller stays partially in synchronization without attachments until the host notebook 404 wakes up and connects with the email server 402 over the WLAN.

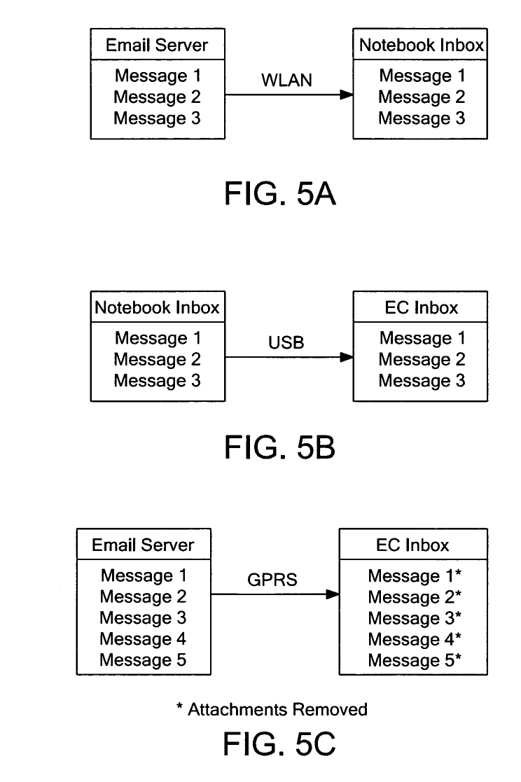

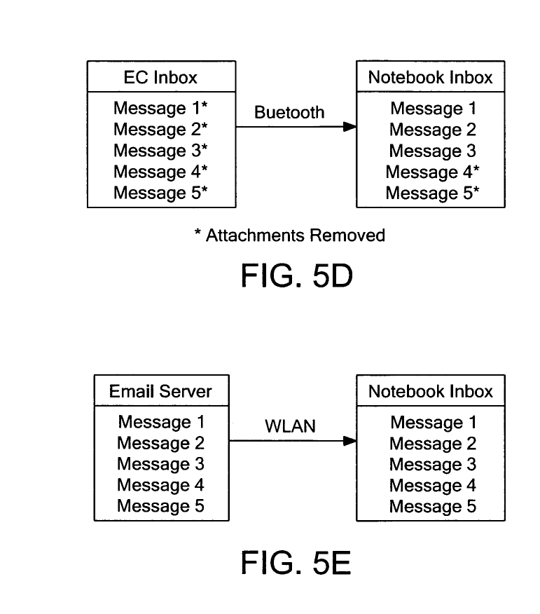

The Road-warrior initially downloads the email to his notebook from the email server over a high bandwidth WLAN connection in his workplace, as shown in FIG. 5a. The notebook synchronizes the local database with the Embedded Controller's inbox over the internal link. The notebook email client recognizes the limited device capabilities of the embedded controller and transforms the emails by removing attachments, as shown in FIG. 5b. The traveler then heads to the airport, boards the airplane and uses his notebook in flight.

Once in the destination airport the traveler cannot find a convenient WLAN hot-spot so he requests his Embedded Controller to connect with the master database via GPRS. The server sends two new messages with attachments removed, as shown in FIG. 5c. This is accomplished while the notebook itself remains in a power saving standby mode.

The traveler then opens his notebook which synchronizes with the EC database over the internal link. The two new scaled down messages are copied from the EC database to the notebook's inbox, as shown in FIG. 5d.

At the end of the day, the traveler then reaches his destination hotel and finds a local WLAN hot-spot so he connects his notebook to the master email server and replaces the two new messages in the notebook database with their full versions including attachments, as shown in FIG. 5e. In both examples above, one embodiment of the present invention works to synchronize based on availability of networks and device capabilities.

The processes described above can be stored in a memory of a computer, system, or machine as a set of instructions to be executed by a processor of the computer system or machine. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
in response to a request to synchronize data between a first device and a second device, copying one or more data items and corresponding quality indicators listed on the first device onto the second device; and
if a first data item from the first device was previously stored on the second device and a quality indicator of the first data item from the first device is higher than a quality indicator of the first data item previously stored on the second device, replacing the first data item previously stored the second device with the first data item from the first device.

2. The method of claim 1, further comprising inserting one or more data items from the first device into a list of data items on the second device that were not previously stored in the list of data items on the second device.

3. The method of claim 2, further comprising assigning a quality indicator to the one or more data items inserted into the list of data items on the second device that were not previously stored in the list of data items on the second device.

4. The method of claim 3, wherein the first device and the second device are peers in a network, and the first data device obtained copies of the one or more data items from a master database.

5. The method of claim 3, wherein the first device is one of a set comprising of a mobile computer, a personal digital assistant (PDA), cellular phone.

6. The method of claim 5, wherein the copying of the one or more data items further includes transmitting the one or more data items via a wireless communication comprising one of a Wireless Local Area Network, a Bluetooth connection, and a General Packet Radio Service (GPRS).

7. A method comprising:
Receiving a list of data items and corresponding quality factors during a process of synchronizing data on a mobile device; and
Replacing one or more data items if a quality factor of a corresponding data item received is higher than the corresponding data item previously stored on the mobile device.

8. The method of claim 7, further comprising saving one or more data items received if the data items were not previously stored on the mobile device.

9. The method of claim 8, wherein the mobile device is one of a set comprising of a mobile computer, a personal digital assistant (PDA), cellular phone.

10. A machine-accessible medium that provides instructions that, if executed by a machine will cause said machine to perform operations comprising of:
in response to a request to synchronize data between a first device and a second device, copying one or more data items and corresponding quality indicators listed on the first device onto the second device; and
if a first data item from the first device was previously stored on the second device and a quality indicator of the first data item from the first device is higher than a quality indicator of the first data item previously stored on the second device, replacing the first data item previously stored the second device with the first data item from the first device.

11. The machine-accessible medium of claim 10, wherein the machine readable medium further includes instructions which when executed further perform inserting one or more data items from the first device into a list of data items on the second device that were not previously stored in the list of data items on the second device.

12. The machine-accessible medium of claim 11, wherein the machine readable medium further includes instructions which when executed further perform assigning a quality indicator to the one or more data items inserted into the list of data items on the second device that were not previously stored in the list of data items on the second device.

13. The machine-accessible medium of claim 12, wherein the first device and the second device are peers in a network, and the first data device obtained copies of the one or more data items from a master database.

14. A machine-accessible medium that provides instructions that, if executed by a machine will cause said machine to perform operations comprising of:
Receiving a list of data items and corresponding quality factors during a process synchronizing data on a mobile device; and
Replacing one or more data items if a quality factor of a corresponding data item received is higher than the corresponding data item previously stored on the mobile device.

15. The machine-accessible medium of claim 14, wherein the machine readable medium further includes instructions which when executed further perform saving one or more data items received if the data items were not previously stored on the mobile device.

16. The machine-accessible medium of claim 14, wherein the mobile device is one of a set comprising of a mobile computer, a personal digital assistant (PDA), cellular phone.

17. A system comprising:
a processor;
a network interface coupled to the processor; and
a machine-readable medium having stored thereon a set of instructions which when executed cause a system to perform a method comprising of:
in response to a request to synchronize data between a first device and a second device, copying one or more data items and corresponding quality indicators listed on the first device onto the second device; and
if a first data item from the first device was previously stored on the second device and a quality indicator of the first data item from the first device is higher than a quality indicator of the first data item previously stored on the second device, replacing the first data item previously stored the second device with the first data item from the first device.

18. The system of claim 17, wherein the machine readable medium further includes instructions which when executed further perform inserting one or more data items from the first device into a list of data items on the second device that were not previously stored in the list of data items on the second device.

19. The system of claim 18, wherein the machine readable medium further includes instructions which when executed further perform assigning a quality indicator to the one or more data items inserted into the list of data items on the second device that were not previously stored in the list of data items on the second device.

20. The system of claim 19, wherein the first device and the second device are peers in a network, and the first data device obtained copies of the one or more data items from a master database.

21. A system comprising:
a processor;
a network interface coupled to the processor; and
a machine-readable medium having stored thereon a set of instructions which when executed cause a system to perform a method comprising of:
receiving a list of data items and corresponding quality factors during a process synchronizing data on a mobile device; and
replacing one or more data items if a quality factor of a corresponding data item received is higher than the corresponding data item previously stored on the mobile device.

22. The system of claim 21, wherein the machine readable medium further includes instructions which when executed further perform saving one or more data items received if the data items were not previously stored on the mobile device.

23. The system of claim 22, wherein the mobile device is one of a set comprising of a mobile computer, a personal digital assistant (PDA), cellular phone.
